(19) United States
(12) Patent Application Publication
(10) Pub. No.: US 2024/0079699 A1
(43) Pub. Date: Mar. 7, 2024

(54) LEAK-PROOF BIPOLAR BATTERY

(71) Applicant: GM GLOBAL TECHNOLOGY OPERATIONS LLC, Detroit, MI (US)

(72) Inventors: Zhe LI, Shanghai (CN); Meiyuan WU, Shanghai (CN); Qili SU, Shanghai (CN); Yong LU, Shanghai (CN); Haijing LIU, Shanghai (CN)

(21) Appl. No.: 18/364,203

(22) Filed: Aug. 2, 2023

Related U.S. Application Data
(63) Continuation-in-part of application No. 17/961,804, filed on Oct. 7, 2022.

(30) Foreign Application Priority Data
Sep. 2, 2022 (CN) 202211070259.4

(51) Int. Cl. H01M 50/186; H01M 4/66; H01M 4/70; H01M 10/0585; H01M 50/112; H01M 50/148; H01M 50/174; H01M 50/193; H01M 50/198; H01M 50/30; H01M 50/548

(52) U.S. Cl. CPC H01M 50/186; H01M 4/661; H01M 4/667; H01M 4/70; H01M 10/0585; H01M 50/112; H01M 50/148; H01M 50/174; H01M 50/193; H01M 50/198; H01M 50/30; H01M 50/548; H01M 2004/029

(57) ABSTRACT

A bipolar battery includes N battery cores each comprising a cathode electrode, an anode electrode, and a separator, where N is an integer greater than one. N−1 bipolar plates include a first layer made of a first material, a second layer made of a second material, a center portion, and first and second sides extending transversely relative to the center portion. A battery enclosure including a cover and a lower portion including sides defining a cavity. The N−1 bipolar plates are arranged in the cavity between adjacent ones of the N battery cores and the N battery cores are connected in series by the N−1 bipolar plates. The first and second sides of the N−1 bipolar plates are one of inserted into “L”-shaped slots in the sides of the lower portion, and molded into the sides of the lower portion.

### CROSS-REFERENCE TO RELATED APPLICATIONS

This application is a continuation-in-part of U.S. patent application Ser. No. 17/961,804, filed on Oct. 7, 2022, which claims the benefit of Chinese Patent Application No. 202211070259.4, filed on Sep. 2, 2022. The entire disclosures of the applications referenced above are incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to bipolar batteries, and more particularly to a leak-proof battery enclosure for a bipolar battery.

Low voltage automotive battery systems such as 12V battery systems can be used for starting vehicles, supporting stop/start functionality, and/or supplying vehicle accessory loads or other vehicle systems. Low voltage automotive battery systems can also be used to support vehicle accessory loads in electric vehicles (EVs) such as battery electric vehicles, hybrid vehicles and/or fuel cell vehicles.

During cold starting or stop/start events, the battery system supplies current to a starter to crank the engine. When the vehicle is cold started, the battery needs to supply sufficient cranking power. In some applications, the battery system may continue to supply power for various electrical systems of the vehicle after the engine is started. An alternator or regeneration recharges the battery system.

### SUMMARY

A bipolar battery includes N battery cores each comprising a cathode electrode, an anode electrode, and a separator, where N is an integer greater than one. N−1 bipolar plates include a first layer made of a first material, a second layer made of a second material, a center portion, and first and second sides extending transversely relative to the center portion. A battery enclosure including a cover and a lower portion including sides defining a cavity. The N−1 bipolar plates are arranged in the cavity between adjacent ones of the N battery cores and the N battery cores are connected in series by the N−1 bipolar plates. The first and second sides of the N−1 bipolar plates are one of inserted into “L”-shaped slots in the sides of the lower portion, and molded into the sides of the lower portion.

In other features an adhesive attaching the first and second sides of the N−1 bipolar plates in the “L”-shaped slots. One or more sealing strips arranged between mating surfaces of the cover and the lower portion. The one or more sealing strips include one or more materials selected from a group consisting of hot-melt adhesive, polyethylene resin, polypropylene resin, a resin including an amorphous polypropylene resin, polypropylene, butene, silicone, polyimide resin, epoxy resin, poly(styrene-butadiene-styrene), acrylic resin, rubber, isocyanate adhesive, acrylic resin adhesive, and/or cyanoacrylate adhesive.

In other features, a first terminal passing through one side of the battery enclosure and contacting a cathode current collector of a first one of the N battery cores. A second terminal passes through an opposite side of the battery enclosure and contacting an anode current collector of a last one of the N battery cores. The first terminal includes a first “O”-ring and the second terminal includes a second “O”-ring arranged between the first terminal and the second terminal and the battery enclosure, respectively.

In other features, the N−1 bipolar plates include a bottom edge coated with an adhesive, the bottom edge extends transversely relative to the center portion, and the bottom edge is molded into a bottom surface of the lower portion. The first material of the N−1 bipolar plates comprises copper and the second material of the N−1 bipolar plates comprises aluminum. The N battery cores comprise liquid electrolyte. The N battery cores comprise solid electrolyte and at least one of liquid electrolyte and gel electrolyte. The N battery cores comprise solid electrolyte.

In other features, the cover includes N vent holes arranged between the N−1 bipolar plates, between a first one of the N−1 bipolar plates and one side of the battery enclosure, and between a last one of the N−1 bipolar plates and an opposite side of the battery enclosure. N fasteners are arranged in the N vent holes. Sealing polymer sealing the N fasteners in the N vent holes.

A bipolar battery comprises N battery cores each comprising a cathode electrode, an anode electrode, and a separator; N−1 bipolar plates includes a first layer made of a first material, a second layer made of a second material, a center portion, and a first side, a second side, and a bottom edge extending transversely relative to the center portion. The N−1 bipolar plates are arranged between adjacent ones of the N battery cores. The N battery cores are connected in series by the N−1 bipolar plates. A battery enclosure includes a cover and a lower portion defining a cavity, sides and a bottom surface. The N battery cores and the N−1 bipolar plates are arranged in the cavity, and the first and second sides and the bottom edge of the N−1 bipolar plates are molded into the sides and the bottom surface of the lower portion. A first terminal passes through one side of the battery enclosure, contacting a cathode current collector of a first one of the N battery cores, and including a first “O”-ring providing a first seal between the first terminal and the battery enclosure. A second terminal passes through an opposite side of the battery enclosure, contacting an anode current collector of a last one of the N battery cores, and including a second “O”-ring to provide a second seal between the second terminal and the battery enclosure.

In other features, one or more sealing strips arranged between mating surfaces of the cover and the lower portion. The one or more sealing strips include one or more materials selected from a group consisting of hot-melt adhesive, polyethylene resin, polypropylene resin, a resin including an amorphous polypropylene resin, polypropylene, butene, silicone, polyimide resin, epoxy resin, poly(styrene-butadiene-styrene) (SBS), acrylic resin, rubber (ethylene-polypropylene diene rubber) (EPDM), isocyanate adhesive, acrylic resin adhesive, and/or cyanoacrylate adhesive. In some examples, the hot-melt adhesive comprises urethane resin, polyamide resin, and polyolefin resin.

In other features, the cathode current collector comprises aluminum and the anode current collector comprises copper. The first material of the N−1 bipolar plates comprises copper and the second material of the N−1 bipolar plates comprises aluminum. The N battery cores further comprise one of liquid electrolyte; solid electrolyte and at least one of liquid electrolyte and gel electrolyte; and solid electrolyte.

In other features, the cover includes N vent holes arranged between the N−1 bipolar plates, between a first one of the N−1 bipolar plates and one side of the battery enclosure, and between a last one of the N−1 bipolar plates and an opposite side of the battery enclosure; N fasteners arranged in the N vent holes; and sealing polymer sealing the N fasteners in the N vent holes.

A bipolar battery comprises N battery cores each comprising a cathode electrode, an anode electrode, and a separator. N−1 bipolar plates include a first layer made of a first material, a second layer made of a second material, a center portion, and a first side, a second side and a bottom edge extending transversely relative to the center portion. The N−1 bipolar plates are arranged between adjacent ones of the N battery cores. The N battery cores are connected in series by the N−1 bipolar plates. A battery enclosure includes a cover and a lower portion defining a cavity, sides and a bottom surface. The N battery cores and the N−1 bipolar plates are arranged in the cavity, the first side, the second side, and the bottom edge of the N−1 bipolar plates are molded into the sides and the bottom surface of the lower portion of the battery enclosure. A sealing strip is arranged between mating surfaces of the cover and the lower portion of the battery enclosure. A first terminal is in contact with a cathode current collector of a first one of the N battery cores, passes through one side of the battery enclosure, and includes a first “O”-ring to provide a first seal between the first terminal and the battery enclosure, respectively. A second terminal is in contact with an anode current collector of a last one of the N battery cores, passes through an opposite side of the battery enclosure, and includes a second “O”-ring to provide a second seal between the second terminal and the battery enclosure.

In other features, the first side, the second side, and the bottom edge of the N−1 bipolar plates are coated with adhesive.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a bipolar battery including a plurality of battery cell cores according to the present disclosure;

FIG. 2 is a perspective view of an example of a battery cell core according to the present disclosure;

FIG. 3 is a side cross-sectional view of an example of a bipolar battery including battery cell cores arranged in a leak-proof battery enclosure according to the present disclosure;

FIG. 4 is a top perspective view of an example of a cover of the battery enclosure according to the present disclosure;

FIG. 5 is a bottom perspective view of an example of a cover of the battery enclosure according to the present disclosure;

FIG. 6 is a partial side cross-section view of an example of an edge of the cover according to the present disclosure;

FIG. 7A is a perspective exploded view of another example of a battery enclosure according to the present disclosure;

FIG. 7B is a side view of an example of a terminal according to the present disclosure;

FIG. 7C is a side cross-section view of an example of a terminal according to the present disclosure;

FIG. 8A is a plan view of an example of an enclosure including bipolar plates arranged in sides of the enclosure according to the present disclosure;

FIG. 8B is a plan view of an example of a bipolar plate according to the present disclosure;

FIG. 9A is a plan view of another example of an enclosure including bipolar plates arranged in sides of the enclosure according to the present disclosure; and

FIG. 9B is a plan view of another example of a bipolar plate according to the present disclosure.

In the drawings, reference numbers may be reused to identify similar and/or identical elements.

### DETAILED DESCRIPTION

While the bipolar battery and the battery enclosure according to the present disclosure are described below in the context of a vehicle, the bipolar battery and the battery enclosure according to the present disclosure can be used in other applications.

Bipolar batteries according to the present disclosure include anode electrodes, cathode electrodes, and separators that are arranged as a battery cell core. Then, multiple battery cell cores are connected in series between bipolar plates to form a bipolar battery. The bipolar plates are integrated with a lower portion of the battery enclosure to improve sealing.

The anode electrodes and cathode electrodes can be fabricated using traditional lithium-ion battery (LIB) fabrication to ensure cell consistency. The bipolar plates support series connection of the battery cells and higher output voltages. The bipolar plates provide fast electron transportation with short electron pathways. The battery enclosure is light weight and hermetically sealed to prevent moisture and oxygen flow and leakage of the electrolyte. The battery is tab free, which will increase reliability.

Bipolar batteries according to the present disclosure improve the energy density by reducing the number of connecting tabs, battery packages, and/or cooling systems that are needed for a desired amp hour (Ah) capacity. The voltage output of the bipolar battery can be increased by increasing the number of series-connected battery cells. However, it is very difficult to fabricate Ah-level cell/modules for 12V start/stop applications, in terms of electrochemical performance and fabrication processes.

Leakage can occur when a cover and a lower portion of the battery enclosure do not have sufficiently close tolerances. Leakage of electrolyte and/or gas can also occur between the terminals and the battery enclosure. Poor fit between the enclosure and the bipolar plates can cause leakage of electrolyte between the battery cell cores (especially at high temperatures), which may lead to ionic short circuits.

In some examples, an enclosure of the bipolar battery includes terminals with sealing “O”-rings to improve sealing at the terminals. In some examples, the bipolar plates include sides and/or a bottom edge with an adhesive coating to bond the bipolar plates to sides and a bottom surface of the battery enclosure to improve sealing. In some examples, one or more sealing strips are arranged between mating surfaces of the cover and the body portion of the battery enclosure to improve sealing.

The battery cells can include liquid-based battery cell cores, semi-solid-state battery cell cores, and/or all-solid-state battery cell cores. The improved sealing prevents leakage of electrolyte and/or gases from one battery cell core to another battery cell core and/or to the environment. As a result, leakage and/or ionic short circuits are reduced.

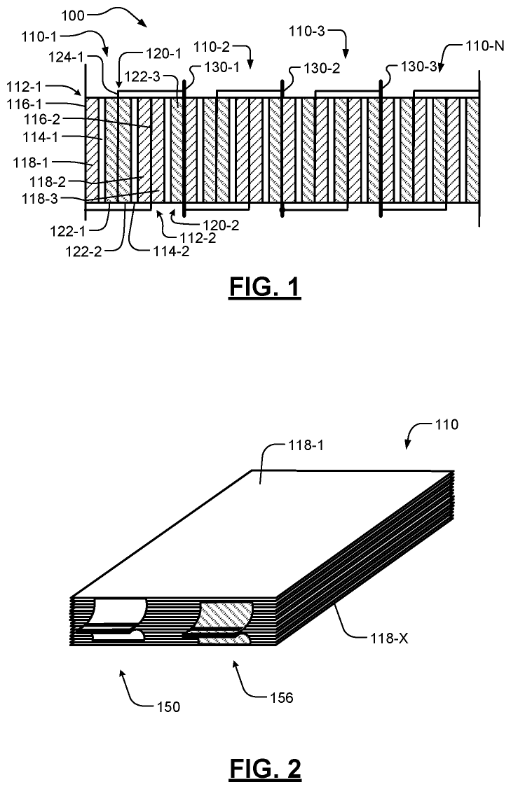

Referring now to FIG. 1, an example of a bipolar battery 100 including N battery cell cores 110-1, 110-2, 110-3, . . . , and 110-N is shown, where N is an integer greater than one. In this example, each of the N battery cell cores 110-1, 110-2, 110-3, . . . , and 110-N include one or more cathode electrodes, one or more anode electrodes, and one or more separators.

In the example in FIG. 1, a cathode electrode 112-1 is arranged adjacent to a separator 114-1. The cathode electrode 112-1 includes a cathode current collector 116-1 and a cathode active layer 118-1 including cathode active material. An anode electrode 120-1 is arranged adjacent to the separator 114-1. The anode electrode 120-1 includes anode active layers 122-1 and 122-2 (including anode active material) arranged on opposite sides of an anode current collector 124-1. A separator 114-2 is arranged adjacent to the anode electrode 120-1.

A cathode electrode 112-2 is arranged adjacent to the separator 114-2. The cathode electrode 112-2 includes cathode active layers 118-2 and 118-3 (including cathode active material) arranged opposite sides of a cathode current collector 116-2. A separator layer 114-3 is arranged adjacent to the cathode electrode 112-2. An anode electrode 120-2 includes an anode active layer 122-3 arranged on an anode current collector forming part of or in contact with a bipolar plate 130-1.

The battery core 110-2 is arranged between the bipolar plate 130-1 and a bipolar plate 130-2. In other words, a leftmost cathode current collector of the next battery core is in contact with an opposite side of the bipolar plate 130-1. The battery core 110-3 is arranged between the bipolar plate 130-2 and a bipolar plate 130-3 and so on.

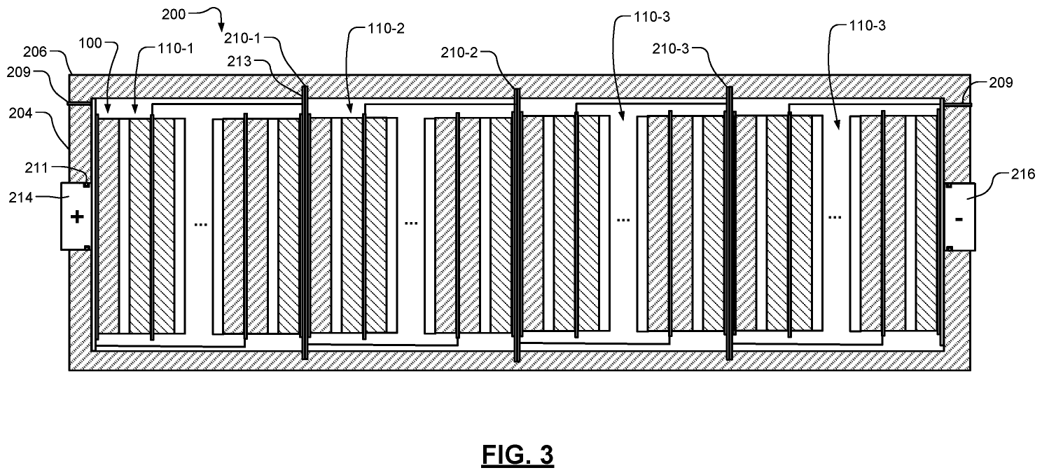

While each of the battery cell cores 110 are shown to include three pairs of anode electrodes and cathode electrodes, additional anode electrodes, cathode electrodes, and separators can be used and connected in a similar manner (as generally shown in the example in FIG. 3). In some examples, N=4, although additional or fewer bipolar battery cells can be used.

Referring now to FIG. 2, the battery cell core 110 is shown after welding of external terminals. Terminals 150 are connected to cathode current collectors. Terminals 156 are connected to anode current collectors. The terminals 150 are shorted. The terminals 156 are shorted. In some examples, the terminals are welded together, respectively. As can be appreciated, the terminals can be arranged on the same side (e.g., FIG. 2) or different sides of the battery cells (e.g., FIG. 1).

In some examples, an outermost cathode current collector 118-X includes a single layer to enable fast current flow to the bipolar plates and/or terminals. The battery cells can include liquid-based battery cell cores, semi-solid-state battery cell cores with solid electrolyte and gel or liquid electrolyte, and/or all-solid-state battery cell cores with solid electrolyte.

Referring now to FIG. 3, the bipolar battery 100 is shown arranged in a battery enclosure 200. The battery enclosure 200 includes a lower portion 204 defining a cavity and a cover 206. In some examples, one or more sealing strips 209 are located between mating surfaces of the lower portion 204 and the cover 206 to provide a seal. The sealing strips 209 prevent unwanted leakage of electrolyte and/or gas between the cover 206 and the lower portion 204.

In some examples, the sealing strips 209 are made of one or more materials selected from a group consisting of hot-melt adhesive, polyethylene resin, polypropylene resin, a resin including an amorphous polypropylene resin, polypropylene, butene, silicone, polyimide resin, epoxy resin, poly(styrene-butadiene-styrene) (SBS), acrylic resin, rubber (ethylene-polypropylene diene rubber) (EPDM), isocyanate adhesive, acrylic resin adhesive, and/or cyanoacrylate adhesive. In some examples, the hot-melt adhesive comprises urethane resin, polyamide resin, and/or polyolefin resin. In some examples, the amorphous polypropylene resin is obtained by copolymerizing ethylene. In some examples, the sealing strip has a length in a range from 4 to 300 mm, a height in a range from 1 to 500 μm, and/or a width in a range from 0.5 to 10 mm.

In some examples, the lower portion 204 of the battery enclosure 200 has a rectangular cross-section. The lower portion 204 includes a bottom surface, first and second side walls, and first and second end walls. Bipolar plates 210-1, 210-2, and 210-3 are arranged between and integrated with the first and second sidewalls and the bottom surface. Outermost ones of the adjacent battery cell cores are arranged between a terminal 214 and one of the bipolar plates and a terminal 216 and another one of the bipolar plates, respectively. In some examples, the terminals 214 and 216 include O-rings 211 to improve sealing with the battery enclosure 200.

In some examples, the bipolar plates 210-1, 210-2, and 210-3 are molded into or received in slots 213 formed on a top of side surfaces of the lower portion 204, the bottom surface of the lower portion 204, and/or the cover 206 of the battery enclosure 200. In this example, the battery cell core 110-1 is arranged between a terminal 214 (e.g., a positive terminal) and the bipolar plate 210-1. The battery cell core 110-2 is arranged between the bipolar plate 210-1 and the bipolar plate 210-2. The battery cell core 110-3 is arranged between the bipolar plate 210-2 and the bipolar plate 210-3. The battery cell core 110-4 is arranged between the bipolar plate 210-3 and the terminal 216 (e.g., a negative terminal). As can be appreciated, additional or fewer battery cells and bipolar plates can be used to provide different voltage output levels.

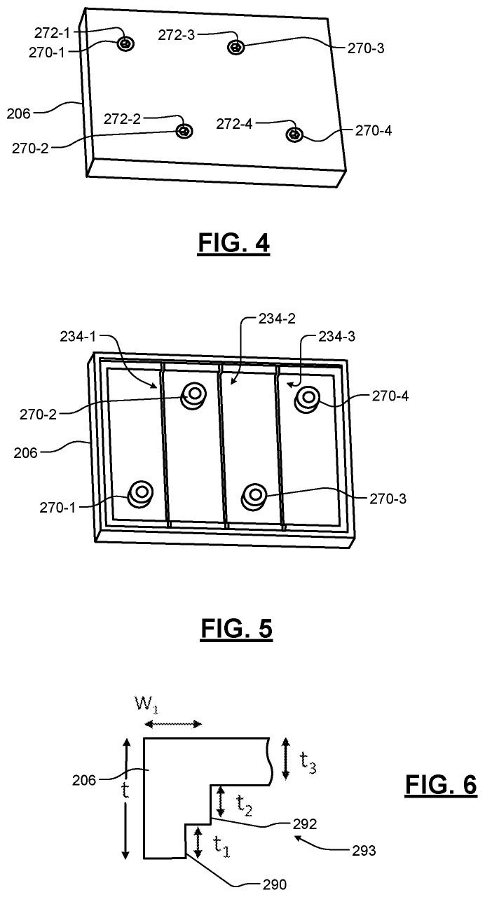

Referring now to FIGS. 4 and 5, top and bottom surfaces of the cover 206 of the battery enclosure 200 are shown, respectively. The cover 206 includes vent holes 270-1, 270-2, 270-3, and 270-4, respectively, corresponding to each of the battery cell cores 110-1, 110-2, 110-3, and 110-4. In some examples, fasteners 272-1, 272-2, 272-3, and 272-4 are arranged in the vent holes 270-1, 270-2, 270-3, and 270-4, respectively, after filling the battery enclosure with polymer electrolyte or liquid electrolyte. Sealing polymer may be used to seal and fix the fasteners 272 in place.

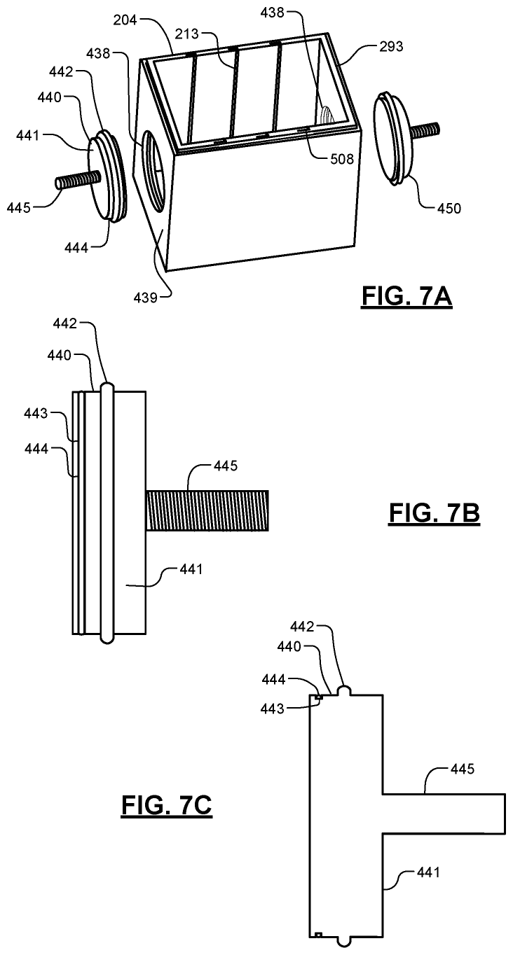

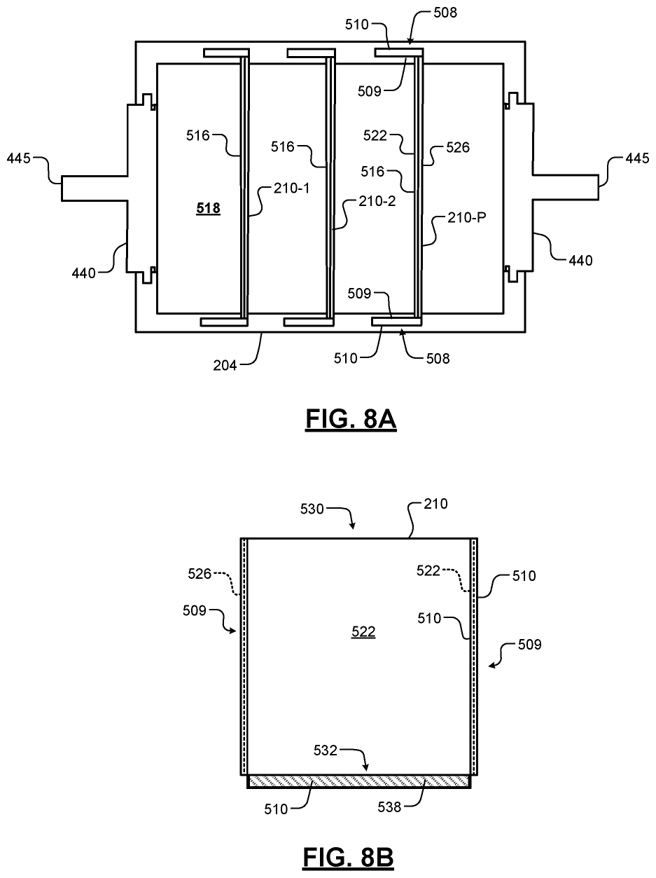

In FIG. 6, the cover 206 includes a first stair-stepped surface including a first step 290 and a second step 292. Upper edges of the lower portion 204 include a second stair-stepped surface 293 (FIG. 7A) that mates with the first stair-stepped surface. Slots 234-1, 234-2, and 234-3 receive the P bipolar plates 210 to maintain positions the P bipolar plates 210 in the battery enclosure 200. In some examples, the thickness t3 of the body of the cover 206 inward of the first and second steps is in a range from 0.5 mm to 10 mm. In some examples, the thickness t2 of the first step 290 is in a range from 0.5 mm to 3 mm. In some examples, the thickness t1 of the second step 292 is in a range from 0.5 mm to 3 mm. In some examples, the combined width of the first step 290 and the second step 292 is in a range from 0.5 to 10 mm. In some example, t=t1+t2+t3.

In some examples, the vent holes 270-1, 270-2, 270-3, and 270-4 are configured to receive and distribute polymer or gel electrolyte during manufacture and allow gas to escape during polymerization. After polymerization, the vent holes 270-1, 270-2, 270-3, and 270-4 are sealed by a fastener and a sealing polymer.

In some examples, the edge of the cover 202 and a mating surface of the lower portion 204 of the battery enclosure are machined with tolerances that closely match. The one or more sealing strips 209 provide a seal between the cover 206 and the lower portion 204. In some examples, the cover 206 and the lower portion 204 of the battery enclosure 200 are made of a material selected from a group consisting of polyvinyl chloride (PVC), polyvinylidene fluoride (PVDF), polytetrafluoethylene (PTFE), chlorinated polyvinyl chloride (CPVC), chlorinated polyethylene (CPE), polypropylene (PP), polyethylene (PE), polybutylene (PB), and combinations thereof. In some examples, the lower portion 204 and/or the cover 206 of the battery enclosure 200 include a flame-retardant polymer such as acrylonitrile butadiene styrene (ABS).

In some examples, the lower portion 204 of the battery enclosure 200 has a thickness in a range from 0.5 mm to 20 mm. In some examples, the slots 234 in the cover 206 have a depth in a range from 0.2 mm to 5 mm and a width greater than or equal to a thickness of the P bipolar plates 210.

Referring now to FIGS. 7A to 7C, details relating to the terminals are shown. In FIG. 7A, examples of the lower portion 204 of a battery enclosure and terminals 440 and 450 are shown, respectively. The terminals 440 and 450 correspond to a positive terminal or a negative terminal. An opening 438 is arranged in an end wall 439 of the lower portion 204 of the battery enclosure and is configured to receive the terminal 440. In some examples, the lower portion 204 is injection molded around the terminal 440.

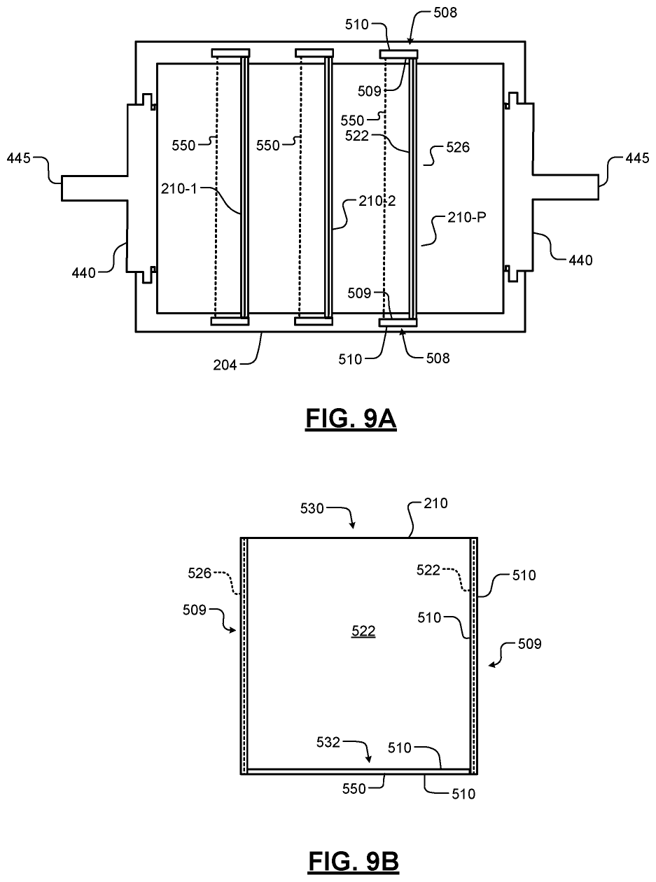

In some examples, the terminal 440 comprises a flat cylinder 441 and a flange 442 extending radially outwardly therefrom. The flange 442 helps to retain the terminal 440 in the opening 438 after molding. An O-ring seal 444 is arranged in a groove 443 arranged on a radially outer surface of the flat cylinder 441 on a battery cell side of the flange 442 to provide a seal. A cylindrical projection 445 extends from the flat cylinder 441. In some examples, the cylindrical projection 445 includes threads. “L”-shaped slots 508 in side walls of the lower portion 204 receive and/or surround sides of the bipolar plates as best seen in FIG. 8A. A terminal 450 is likewise arranged in the opening 438 on an opposite end wall and has a similar configuration.

In some examples, the positive terminal is made of a material selected from a group consisting of stainless steel, aluminum, nickel, iron, titanium, tin, and alloys thereof. In some examples, the negative terminal is made of a material selected from a group consisting of stainless steel, copper, nickel, iron, titanium, tin, and alloys thereof. In some examples, the lower portion 204 has a height in a range from 4 mm to 280 mm, a length in a range from 4 mm to 400 mm, and a width in a range from 4 mm to 280 mm.

The terminals 440 and 450 include the O-ring seals 444 to provide a seal against end walls of the lower portion. In some examples, the O-ring seals 444 are made of a material selected from a group consisting of nitrile, hydrogenated nitrile, polyacrylate, ethylene-propylene, chloroprene butyl, PTFE, silicone, fluorosilicone, and/or fluorocarbon. In some examples, a thickness of the threaded portion is in a range from 0.2 mm to 10 mm and has a length in a range from 0 to 60 mm. In some examples, the flat cylindrical body has a thickness in an axial direction in a range from 8 mm to 30 mm and a diameter in a range from 2 mm to 10 mm. In some examples, the flange 442 has a length in a range from 2 mm to 10 mm. In some examples, the “O”-ring has a radial thickness in a range from 0.5 mm to 5 mm.

Referring now to FIGS. 8A and 8B, an example of the P bipolar plates 210 is shown. P bipolar plates 210-1, 210-2, . . . , and/or 210-P (collectively or individually P bipolar plates 210) are arranged in and/or integrated with sides of the lower portion 204. “L”-shaped slots 508 (in sides of the lower portion 204) receive and/or surround first and second sides 509 of the P bipolar plates 210. In some examples, the bipolar battery includes C=P+1 battery cell cores. In some examples, C=2 battery cell cores for 6V, C=4 cell cores for 12V, or C=16 cell cores for 48V. However, C and P can be varied for voltages in a range from 6V to 400V or higher.

Bottom edges 532 of center portions 530 of the P bipolar plates 210 are arranged in P slots 516 formed in a bottom surface 518 of the lower portion 204. In some examples, the bottom edge 532 extends below the first and second sides 509. In some examples, the first and second sides 509 extend to the bottom edges 532. In some examples, the bottom edge 532 is coated with the adhesive 510.

An adhesive 510 is applied or coated on the first and second sides 509 of the P bipolar plates 210 (or in the “L”-shaped slots 508) and along the bottom edge 532 of the center portion 530 of the P bipolar plates 210 (or in the P slots 516) to attach the P bipolar plates 210 to the first and second sides 509 and the bottom surface 518 of the lower portion 204.

The P bipolar plates 210 have a “C”-shaped configuration and include a first layer 522 and a second layer 526. In some examples, first and second sides 509 of the first layer 522 and the second layer 526 extend in a transverse direction relative to a center portion 530 thereof. The arrangement in FIGS. 8A and 8B can be used after the lower portion is molded or can be inserted in the mold and the lower portion 204 is molded around the P bipolar plates 210.

Referring now to FIGS. 9A and 9B, another example of the P bipolar plates 210 is shown. The P bipolar plates 210-1, 210-2, . . . , and/or 210-P (collectively or individually P bipolar plates 210) are arranged in and/or integrated with the lower portion 204. In this example, a bottom edge 550 of the P bipolar plates 210 abuts, is embedded in, or is molded into a bottom surface of the lower portion 204. The bottom edge 550 extends transversely from the center portion 530 and is connected to the first and second sides 509. The P bipolar plates in FIGS. 9A and 9B is inserted into a mold and the lower portion 204 is molded around the P bipolar plates 210. As described above, the first and second sides 509 and the bottom edge 550 can be coated with the adhesive 510.

In some examples, the P bipolar plates 210 comprise an aluminum-copper (Al—Cu) foil with a thickness in a range from 0.2 mm to 5 mm (e.g., 1 mm). In other examples, the bipolar plates include other materials such as stainless steel (SS), nickel-titanium (Ni—Ti), Ni—Cu, SS—Cu, Al—Ni, Ni—SS, or other alloys. In some examples, the P bipolar plates 210 have a width in a range from 4 mm to 270 mm and the first and second sides 509 have a length in a range from 0.5 mm to 3 mm. In some examples, the first and second sides 509 have a thickness in a range from 0.2 mm to 5 mm (e.g., 1 mm) and are glued into a wall of the lower portion of the enclosure. In some examples, the adhesive 510 comprises poly(styrene-butadiene-styrene) (SBS) and has a thickness in a range from 1 to 200 μm.

In some examples, the enclosure for the bipolar battery is made using plastic injection molding. The mold is fixed, heated polymer is injected into the mold, the mold is filled, the plastic enclosure is allowed to cool, the mold is opened, and an ejector rod moves ejector pins to bias the plastic enclosure to allow removal.

In some examples, the cathode active material is selected from a group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and/or combinations thereof. In some examples, the positive electroactive material is coated (for example, by LiNbO₃ and/or Al₂O₃) and/or the positive electroactive material is doped (for example, by aluminum and/or magnesium).

In some examples, the anode active material is selected from a group consisting of a carbonaceous material, silicon, a transition metal, a metal oxide, a lithium metal, a lithium alloy metal (e.g., tin, aluminum, indium, magnesium) and combinations thereof.

In some examples, the sealing polymer has a thickness in a range from 2 μm to 200 μm. In some examples, the sealing polymer is selected from a group consisting of hot-melt adhesive (e.g., urethane resin, polyamide resin, polyolefin resin), polyethylene resin, polypropylene resin, a resin containing an amorphous polypropylene resin as a main component and obtained by copolymerizing ethylene, propylene, and/or butene, silicone, polyimide resin, epoxy resin, acrylic resin, rubber (ethylene propylenediene rubber (EPDM)), isocyanate adhesive, acrylic resin adhesive, cyanoacrylate adhesive, or combinations thereof.

In some examples, the polymer electrolyte precursor includes a polymer and an initiator. In some examples, the polymer is selected from a group consisting of ethylene oxide (EO), vinylidene fluoride (VDF), vinylidene fluoride-hexafluoropropylene (VDF-HFP), propylene oxide (PO), acrylonitrile (AN), methacrylonitrile (PMAN), methyl methacrylate (MMA), and their corresponding oligomers and co-polymers.

In some examples, the initiators are selected from a group consisting of peroxide, azo compounds, and peroxide and a reducing agent. Examples of peroxide include Di(4-tert-butylcyclohexyl, peroxydicarbonate, and benzoyl peroxide (BPO). An examples of an azo compound includes azodicyandiamide (AIBN). Examples of the reducing agent include a low-valence metal salt such as, S₂O₄²⁻+Fe²⁺, Cr³⁺, Cu⁺.

In some examples, the polymer precursor solution comprises of 0˜5 wt % initiators, 0˜20 wt % polymers, and 80˜99 wt % liquid electrolyte. In other examples, the polymer precursor solution comprises of less than 0.5 wt % initiators, less than 5 wt % polymer, and >90 wt % liquid electrolyte.

In other examples, the liquid electrolyte is selected from a group consisting of traditional electrolyte and ionic liquids. In some examples, the traditional electrolyte comprises carbonate solvents and lithium salts. In some examples, the carbonate solvents are selected from a group consisting of ethylene carbonate (EC), dimethyl carbonate (DMC), ethyl methyl carbonate (EMC), diethyl carbonate (DEC), and propylene carbonate (PC), etc. In some examples, the lithium salts have a concentration >0.8 moles/liter (mol/L).

In some examples, the lithium salts include at least one lithium salt selected from a group consisting of bis(trifluoromethanesulfonyl)imide(LiTFSI), lithium bis(fluorosulfonyl)imide (LIFSI), lithium bis (perfluoroethyl-sulfonyl)imide (LiBETI), lithium hexafluorophosphate (LiPF₆), lithium bis (oxalato)borate (LiBOB), lithium difluoro (oxalato)borate (LiDFOB), lithium tetrafluoroborate (LiBF₄), lithium hexafluoroarsenate (LiAsF₆), lithium perchlorate (LiClO₄), and lithium trifluoromethane sulfonate (LiTfO). In some examples, the traditional electrolyte may further comprise an additive selected from a group consisting of vinylene carbonate (VC), butylene carbonate (BC), fluoroethylene carbonate (FEC), and combinations thereof.

In some examples, the ionic liquids comprise solvated ionic liquids and lithium salts. Examples of solvated ionic liquids include tetraethylene glycol dimethyl ether (G4) and triethylene glycol dimethyl ether (G3). Examples of lithium salts include LiTFSI, LIFSI, LiBETI, LiPF₆, LiBOB, LiDFOB, LiBF₄, LiAsF₆, LiClO₄, and LiTfO.

In other examples, the aprotic ionic liquids include cations, anions and lithium ions. In some examples, the cations are selected from a group consisting of N-methyl-N-propylpiperidinium (PP13+); N-methyl-N-butylpiperidinium (PP14+); N-methyl-N-propylpyrrolidinium (Py13+); 1-ethyl-3-methylimidazolium (EMI+), and combinations thereof. In some examples, the anions are selected from a group consisting of bis(fluorosulfonyl)imide (FSI−); bis(trifluoromethanesulfonyl)imide (TFSI−); bis(pentafluoroethanesulfonyl)imide (BETI−); hexafluorophosphate (PF₆−); tetrafluoroborate (BF4−); trifluoromethyl sulfonate (TfO−); difluoroborate (DFOB−) and combinations thereof. The ionic liquids may further comprise a diluent additive selected from a group consisting of 1,1,2,2-tetrafluoroethyl-2,2,3,3-tetrafluoropropyl ether (HFE); fluoroethylene carbonate (FEC); TTE, and combinations thereof.

In some examples, the separator comprises a polypropylene (PP) or polyethylene (PE) layer that is coated with lithium aluminum titanium phosphate (LATP).

In some examples, the electrolyte comprises an oxide-based solid electrolyte selected from a group consisting of doped or undoped garnet electrolyte, perovskite electrolyte, NASICON electrolyte, LISICON electrolyte, and metal-doped or aliovalent-substituted oxide solid electrolyte. Examples of garnet type include Li₇La₃Zr₂O₁₂. Examples of perovskite type include Li₃ₓLa_{2/3-x}TiO₃. Examples of NASICON type include L_{1.4}Al_{0.4}Ti_{1.6}(PO₄)₃ and Li1+x AlxGe₂₋ₓ(PO₄)₃. Examples of LISICON type include Li₂₊₂ₓZn₁₋ₓGeO₄). Examples of metal-doped or aliovalent-substituted oxide solid electrolyte include Al (or Nb)-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, Al-substituted perovskite, Li_{1+x+y}AlₓTi₂₋ₓSi_{y}P_{3-y}O₁₂.

In some examples, a mixture of the liquid electrolyte, precursor solutions and initiator form gel electrolyte insitu in response to heating at 80° C.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A bipolar battery comprising:
N battery cores each comprising a cathode electrode, an anode electrode, and a separator, where N is an integer greater than one;
N−1 bipolar plates including a first layer made of a first material, a second layer made of a second material, a center portion, and first and second sides extending transversely relative to the center portion; and
a battery enclosure including a cover and a lower portion including sides defining a cavity,
wherein the N−1 bipolar plates are arranged in the cavity between adjacent ones of the N battery cores and the N battery cores are connected in series by the N−1 bipolar plates,
the first and second sides of the N−1 bipolar plates are one of:
inserted into “L”-shaped slots in the sides of the lower portion, and
molded into the sides of the lower portion.

2. The bipolar battery of claim 1, further comprising an adhesive attaching the first and second sides of the N−1 bipolar plates in the “L”-shaped slots.

3. The bipolar battery of claim 1, further comprising one or more sealing strips arranged between mating surfaces of the cover and the lower portion.

4. The bipolar battery of claim 3, wherein the one or more sealing strips include one or more materials selected from a group consisting of hot-melt adhesive, polyethylene resin, polypropylene resin, a resin including an amorphous polypropylene resin, polypropylene, butene, silicone, polyimide resin, epoxy resin, poly(styrene-butadiene-styrene), acrylic resin, rubber, isocyanate adhesive, acrylic resin adhesive, and/or cyanoacrylate adhesive.

5. The bipolar battery of claim 1, further comprising:
a first terminal passing through one side of the battery enclosure and contacting a cathode current collector of a first one of the N battery cores; and
a second terminal passing through an opposite side of the battery enclosure and contacting an anode current collector of a last one of the N battery cores,
wherein the first terminal includes a first “O”-ring and the second terminal includes a second “O”-ring arranged between the first terminal and the second terminal and the battery enclosure, respectively.

6. The bipolar battery of claim 1, wherein:
the N−1 bipolar plates include a bottom edge coated with an adhesive,
the bottom edge extends transversely relative to the center portion, and
the bottom edge is molded into a bottom surface of the lower portion.

7. The bipolar battery of claim 1, wherein the first material of the N−1 bipolar plates comprises copper and the second material of the N−1 bipolar plates comprises aluminum.

8. The bipolar battery of claim 1, wherein the N battery cores comprise liquid electrolyte.

9. The bipolar battery of claim 1, wherein the N battery cores comprise solid electrolyte and at least one of liquid electrolyte and gel electrolyte.

10. The bipolar battery of claim 1, wherein the N battery cores comprise solid electrolyte.

11. The bipolar battery of claim 10, wherein the cover includes N vent holes arranged between the N−1 bipolar plates, between a first one of the N−1 bipolar plates and one side of the battery enclosure, and between a last one of the N−1 bipolar plates and an opposite side of the battery enclosure.

12. The bipolar battery of claim 11, further comprising N fasteners arranged in the N vent holes.

13. The bipolar battery of claim 12, further comprising sealing polymer sealing the N fasteners in the N vent holes.

14. A bipolar battery comprising:
N battery cores each comprising a cathode electrode, an anode electrode, and a separator;
N−1 bipolar plates including:
a first layer made of a first material,
a second layer made of a second material,
a center portion, and
a first side, a second side, and a bottom edge extending transversely relative to the center portion,
wherein the N−1 bipolar plates are arranged between adjacent ones of the N battery cores, and
wherein the N battery cores are connected in series by the N−1 bipolar plates;
a battery enclosure including a cover and a lower portion defining a cavity, sides and a bottom surface,
wherein the N battery cores and the N−1 bipolar plates are arranged in the cavity, and the first and second sides and the bottom edge of the N−1 bipolar plates are molded into the sides and the bottom surface of the lower portion;
a first terminal passing through one side of the battery enclosure, contacting a cathode current collector of a first one of the N battery cores, and including a first “O”-ring providing a first seal between the first terminal and the battery enclosure; and
a second terminal passing through an opposite side of the battery enclosure, contacting an anode current collector of a last one of the N battery cores, and including a second “O”-ring to provide a second seal between the second terminal and the battery enclosure.

15. The bipolar battery of claim 14, further comprising:
one or more sealing strips arranged between mating surfaces of the cover and the lower portion,
wherein the one or more sealing strips include one or more materials selected from a group consisting of hot-melt adhesive, polyethylene resin, polypropylene resin, a resin including an amorphous polypropylene resin, polypropylene, butene, silicone, polyimide resin, epoxy resin, poly(styrene-butadiene-styrene) (SBS), acrylic resin, rubber (ethylene-polypropylene diene rubber) (EPDM), isocyanate adhesive, acrylic resin adhesive, and/or cyanoacrylate adhesive. In some examples, the hot-melt adhesive comprises urethane resin, polyamide resin, and polyolefin resin.

16. The bipolar battery of claim 14, wherein:
the cathode current collector comprises aluminum and the anode current collector comprises copper, and
the first material of the N−1 bipolar plates comprises copper and the second material of the N−1 bipolar plates comprises aluminum.

17. The bipolar battery of claim 1, wherein the N battery cores further comprise one of:
liquid electrolyte;
solid electrolyte and at least one of liquid electrolyte and gel electrolyte; and
solid electrolyte.

18. The bipolar battery of claim 11, wherein the cover includes:
N vent holes arranged between the N−1 bipolar plates, between a first one of the N−1 bipolar plates and one side of the battery enclosure, and between a last one of the N−1 bipolar plates and an opposite side of the battery enclosure;
N fasteners arranged in the N vent holes; and
sealing polymer sealing the N fasteners in the N vent holes.

19. A bipolar battery comprising:
N battery cores each comprising a cathode electrode, an anode electrode, and a separator;
N−1 bipolar plates including:
a first layer made of a first material,
a second layer made of a second material,
a center portion, and
a first side, a second side and a bottom edge extending transversely relative to the center portion,
wherein the N−1 bipolar plates are arranged between adjacent ones of the N battery cores, and
wherein the N battery cores are connected in series by the N−1 bipolar plates;
a battery enclosure including a cover and a lower portion defining a cavity, sides and a bottom surface,
wherein the N battery cores and the N−1 bipolar plates are arranged in the cavity, the first side, the second side, and the bottom edge of the N−1 bipolar plates are molded into the sides and the bottom surface of the lower portion of the battery enclosure;
a sealing strip arranged between mating surfaces of the cover and the lower portion of the battery enclosure;
a first terminal in contact with a cathode current collector of a first one of the N battery cores, passing through one side of the battery enclosure, and including a first “O”-ring to provide a first seal between the first terminal and the battery enclosure, respectively; and
a second terminal in contact with an anode current collector of a last one of the N battery cores, passing through an opposite side of the battery enclosure, and including a second “O”-ring to provide a second seal between the second terminal and the battery enclosure.

20. The bipolar battery of claim 19, wherein the first side, the second side, and the bottom edge of the N−1 bipolar plates are coated with adhesive.
